(19) United States
(12) Patent Application Publication
(10) Pub. No.: US 2025/0013842 A1
(43) Pub. Date: Jan. 9, 2025

(54) RAIL SYSTEM AND METHOD FOR CHECKING SAME

(71) Applicant: fischerwerke GmbH & Co. KG, Waldachtal (DE)

(72) Inventor: Lars FREUDIGMANN, Tübingen (DE)

(73) Assignee: fischerwerke GmbH & Co. KG, Waldachtal (DE)

(21) Appl. No.: 18/713,638

(22) PCT Filed: Dec. 2, 2022
(86) PCT No.: PCT/EP2022/084234

§ 371 Date: May 25, 2024

(30) Foreign Application Priority Data
Dec. 16, 2021 (DE) 10 2021 133 381.4

(51) Int. Cl. G06K 7/14

(52) U.S. Cl. CPC G06K 7/1404

(57) ABSTRACT

QR codes or other identification codes are to be attached to an anchor rail and to associated accessory parts such as hammer head screws and attachment parts and an association of the accessory parts with the anchor rail is to be checked with the aid of, for example, a smartphone as an optoelectronic code reader.

The invention relates to a rail system having an anchor or mounting rail having the features of the preamble of claim 1, and a method for checking the rail system according to claim 11.

Anchor and mounting rails serve to fasten attachment parts by means of hammer head screws, the hammerheads of which are or will be transversely set in the anchor rail or mounting rail, or by means of sliding nuts, typically rectangular or diamond-shaped, which are inserted into the anchor or mounting rail. An “anchor rail” is to be understood as a profile rail which is arranged sunk flush with a surface in concrete and typically has anchors projecting into the concrete for anchoring the anchor rail in the concrete. Mounting rails are generally used for mounting building installations, such as for example pipelines, and are typically attached suspended under a ceiling. Anchor and mounting rails are typically C-profile rails.

Patent EP 3 514 297 B1 discloses an anchor rail with holes in a transverse center of a base side of the anchor rail, in which anchors protruding outwardly from the base side of the anchor rail can be fastened to the anchor rail. Holes that are not required are closed with plugs to be cemented so that concrete does not flow into the anchor rail. The plugs have an identification with an identification code for the anchor rail.

The object of the invention is to propose a rail system which, apart from the anchor or mounting rail, has at least one further accessory part which is associated with the anchor or mounting rail, wherein the rail system enables a checking of the association of the anchor rail or mounting rail and of the accessory part. The term “associated accessory part” is to be understood as meaning parts which are provided for use with the anchor or mounting rail, in particular for an arrangement, attachment or fastening to the anchor or mounting rail, to anchor the anchor or mounting rail in, for example, concrete or suspended under a ceiling, or to fasten attachment or other parts to the anchor or mounting rail. Such associated accessory parts are in particular hammer head screws, sliding nuts, angles and brackets, and anchors for anchor rails.

This object is achieved according to the invention by the features of claims 1 and 11. According to the invention, both the anchor or mounting rail and at least one accessory part associated with the anchor or mounting rail have an optoelectronically readable identification code. An optoelectronically readable identification code can be optically read and electronically evaluated or processed using a suitable reading device. It allows a preferably unique identification of the identified component. In particular, one-dimensional identification codes, for example bar codes, two-dimensional identification codes, for example QR codes, and three-dimensional identification codes, for example in the form of holograms, can be used.

Using the invention, it can be easily checked whether accessory parts of the anchor or mounting rail arranged on an anchor or mounting rail are associated, i.e., are provided or not for use with the anchor or mounting rail. In the former case, the accessory parts associated with the anchor or mounting rail are the accessory parts within the meaning of the invention. A use of unsuitable accessory parts, for example of small hammer head elements, is therefore ruled out.

Anchor and/or mounting rails are also referred to below as “rails.”

The rail and the at least one associated accessory part can have identical identification codes or different identification codes. In the case of identical identification codes, no further information is needed: If the identification codes are identical, the accessory parts of the rail are associated and are provided for use with the rail. The accessory part and rail together form a rail system. In the case of different identification codes, additional information is necessary to determine whether or not the identification codes of the rail identify associated accessory parts. However, different identification codes enable a more extensive and variable association. For example, accessory parts can be associated with different rails with which they can be used.

One embodiment of the invention provides a component fastener that can be brought into engagement behind the anchor or mounting rail to fasten an attachment part to the anchor or mounting rail as an accessory part associated with the anchor or mounting rail. Such a component fastener is, for example, a hammer head screw whose hammer head can be transversely adjusted in the anchor or mounting rail in such a way that the hammer head engages behind the anchor or mounting rail so that the attachment part can be fastened to the anchor or mounting rail by means of the hammer head screw. Another such component fastener is a so-called sliding nut which can be introduced into the anchor or mounting rail through a longitudinal slot or at a front end in such a way that it engages behind the anchor or mounting rail, and the attachment part can be fastened to the slide nut and the anchor or mounting rail by means of a threaded rod or screw which can be screwed or is screwed into the sliding nut.

The identification code or codes are preferably arranged at a location of the anchor or mounting rail at which it is accessible for optical reading by an optoelectronic reading device. The identification code is therefore arranged, for example, on the side of an anchor rail which is visible when the anchor rail is arranged in the concrete flush with a surface of the concrete as provided. “Visible” here means optically accessible, i.e., it can be seen. In the case of a mounting rail suspended under a ceiling, the identification code is arranged in particular on a side of the suspended mounting rail that is visible from below or from one side. As a result of this embodiment of the invention, optoelectronic reading of the identification code is possible when the anchor or mounting rail is finally fastened, i.e., for example, cemented in flush in concrete or suspended under a ceiling.

An embodiment of the invention provides multiple, in particular identical, identification codes on the anchor or mounting rail. For example, multiple identical identification codes are arranged distributed uniformly or unevenly over a length on the anchor or mounting rail. If, for example, the anchor or mounting rail is separated into multiple parts, the individual rail parts still have one or more identification codes. In addition, one or more identification codes are very likely to be accessible for optoelectronic reading when one or more identification codes of attachment parts are covered.

An embodiment of the invention provides that an accessory part associated with the anchor or mounting rail has multiple, in particular identical, identification codes at different locations. This increases a probability that at least one of the identification codes is undamaged and visible enough after mounting the accessory part that it can be read electronically, and that, after mounting the accessory, at least one of the identification codes is accessible to an optoelectronic reading device for optoelectronic reading. In particular, the identification code(s) are arranged at a location or at locations of the accessory part which are usually accessible to the optoelectronic reading device for optoelectronic reading after mounting or fastening the accessory part to the anchor or mounting rail.

An embodiment of the invention provides a rotational position marking on the component fastener by means of which a rotational position of the component fastener with respect to the anchor or mounting rail can be detected with the optoelectronic reading device. This embodiment of the invention makes it possible to check whether, for example, the hammer head of a hammer head screw is transversely set as a component fastener in the anchor or mounting rail. The optoelectronic identification code can be used as a rotational position marking, provided that it enables the determination of the rotational position of the identification code and therefore of the component fastener with the optoelectronic reading device. The component fastener can also have a rotational position marking separate from the identification code.

An embodiment of the invention provides an optoelectronic reading device by means of which the identification codes of the anchor rail or mounting rail and of the associated accessory parts are optoelectronically readable and preferably also electronically verifiable or evaluable as part of the rail system. The optoelectronic reading device can also be referred to as an optoelectronic code reader for short. In particular, according to the invention, a smartphone or a tablet computer can be used as an optoelectronic reader on which an app, i.e., application software, is installed for checking and evaluating the identification codes of the anchor rail or mounting rail and the accessory parts fastened or arranged thereon, with which the association of the anchor or mounting rail and the accessory parts or of the at least one accessory part fastened thereto can be checked.

As a further component of the rail system, an embodiment of the invention provides a database in which data relating to the anchor or mounting rail and the associated accessory parts are stored. Such data are initially the association of the parts, i.e., whether a use of the accessory parts with the anchor or mounting rail is provided as a rail system. Further data such as for example edge spacings, tightening torques, production data, the manufacturing site, material and dimensions of the anchor rail or mounting rail and the accessory parts can also be stored in the database. The enumeration is exemplary and not exhaustive. The database can be stored, for example, in the optoelectronic code reader, or online access of the code reader to the database exists, in particular mobile online access.

The method according to the invention provides that the identification codes of the anchor rail or mounting rail and the accessory parts are read with the optoelectronic code reader, and the association of the accessory parts with the anchor or mounting rail is checked. The association is checked in particular after fastening the anchor or mounting rail and one or more accessory parts on the anchor or mounting rail, which does not exclude an additional check before fastening.

The features and feature combinations, embodiments, and designs of the invention as mentioned above in the description, as well as the features and feature combinations as mentioned below in the description of FIGURES and/or drawn in the FIGURE, are usable not only in the combination indicated or shown in each case; rather, in principle any other combinations are also usable, or said features can be used individually. Embodiments of the invention are possible which do not have all features of a dependent claim. Individual features of a claim can also be replaced by other disclosed features or feature combinations. Embodiments of the invention are possible which do not have all the features of the exemplary embodiment, but rather a fundamental arbitrary part of the features of the exemplary embodiment.

The invention is explained in more detail below using an exemplary embodiment illustrated in the drawing. In the drawing:

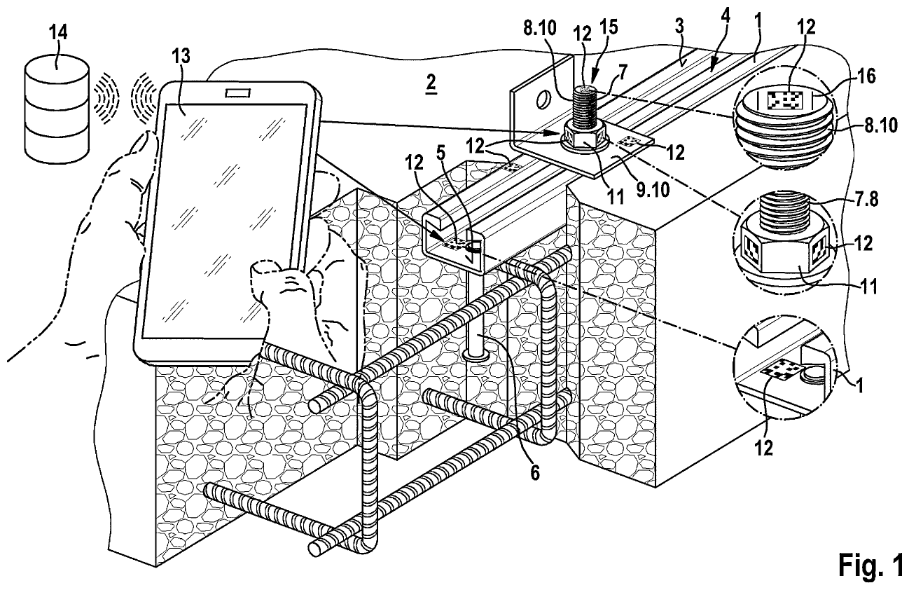

FIG. 1 shows an anchor rail system according to the invention in a perspective, partially cutaway view.

The rail of the rail system according to the invention shown in the exemplary embodiment of the drawing is an anchor rail 1 which is embedded in an anchor base 2 of concrete in such a way that a side of the anchor rail 1, referred to here as the upper side 3, is flush with a surface of the concrete or the anchor base 2. In the exemplary embodiment, the anchor rail 1 is a C-profile rail with a continuous longitudinal slot 4 in the transverse center of the side referred to here as the upper side 3. From a side of the anchor rail 1 opposite the upper side 3, which is referred to here as the base side 5, anchors 6 protrude from the anchor rail 1 which project into the concrete and anchor the anchor rail 1 in the concrete forming the anchor base 2.

A hammer head screw 7 is attached to the anchor rail 1, the hammer head of which that is not visible in the drawing is inserted through the longitudinal slot 4 of the anchor rail 1 into the anchor rail 1 oriented in a longitudinal direction of the anchor rail 1, and is positioned transversely in the anchor rail 1 by being rotated 90° in such a way that the hammer head, which is not visible, engages behind the anchor rail 1.

A metal angle, which has a through-hole for the passage of the screw shank 8, is placed on a screw shank 8 of the hammer head screw 7 which protrudes perpendicularly to the outside from the anchor rail 1. The metal angle is referred to here as an attachment part 9 and, like the hammer head screw 7 and the anchor rail 1, is part of a rail system according to the invention. In summary, the hammer head screw 7, the attachment part 9 and optionally further components associated with the anchor rail 1 can be referred to as accessory parts 10 of the anchor rail 1. “Associated” means that the accessory parts 10 are provided for arrangement or attachment on the anchor rail 1 and form a rail system therewith. The accessory parts 10 can, for example, be fastened to the anchor rail 1 with the hammer head screw 7 or a so-called sliding nut (not shown) which, instead of the hammer head screw 7, is or will be arranged in the anchor rail 1. The hammer head screw 7 or the sliding nut (not shown) can also be referred to collectively as component fasteners 15.

A nut 11 is screwed onto the screw shank 8, with which nut the hammer head screw 7 is clamped from the inside and the attachment part 9 from the outside against the anchor rail 1, and the hammer head screw 7 and the attachment part 9 are thereby fixed to the anchor rail 1. The nut 11 is also an accessory part 10 associated with the anchor rail 1 and a component of the rail system according to the invention. A washer is arranged on the screw shank 8 of the hammer head screw 7 between the nut 11 and the attachment part 9. As described, the rail system according to the invention can also have other attachment parts 9 than the metal angles (not shown).

The anchor rail 1 has DMC codes (data matrix code), i.e., two-dimensional, optoelectronically readable identification codes 12, which are attached to the outside of the upper side 3 and to the inside of the base side 5 of the anchor rail 1. The identification codes 12 are attached to the anchor rail 1 in such a way that they can be read with an optoelectronic reading device, which is referred to here as an optoelectronic code reader 13, when the anchor rail 1 is arranged so as to be recessed in the anchor base 2 as provided in such a way that the upper side 3 of the anchor rail 1 is flush with the surface of the anchor base 2.

The anchor rail 1 has multiple identical identification codes 12 which are attached distributed uniformly or unevenly over a length of the anchor rail 1 on the outside on the upper side 3 and on the inside on the base side 5 of the anchor rail 1. As a result, multiple identification codes 12 of the anchor rail 1 are therefore easily readable, even if multiple identification codes 12 of attachment parts 9 or the like are covered. Other optoelectronically readable identification codes are also possible, for example one-dimensional bar codes or, for example, also holograms or other two- or three-dimensional codes (not shown).

The accessory parts 10 of the rail system according to the invention also have identification codes 12 which are also DMC codes in the exemplary embodiment. The identification codes 12 are also attached to the accessory parts 10 at locations at which they are optoelectronically readable when the accessory parts 10 are arranged or fastened flat on the anchor rail 1. For example, the nut 11 has identification codes 12 on each second of its six key surfaces, and the hammer head screw 7 has an identification code 12 on an end face of its screw shank 8 remote from the hammer head of the hammer head screw 7 (see the detail enlargement in FIG. 1).

Accessories 10 of the rail system according to the invention can have identical identification codes 12, which are identical to the identification codes 12 of the anchor rail 1, as a result of which the association of the accessory parts 10 with the anchor rail 1 can be readily established by checking the identity of the identification codes 12. In the exemplary embodiment, identical accessory parts 10 have identical identification codes 12, and different accessory parts 10 have different identification codes 12, wherein the identification codes 12 of the anchor rail 1 and the identification codes 12 of the accessory parts 10 are likewise different. It is also possible for each component to have an individual identification code 12.

As an optoelectronic code reader 13, the rail system according to the invention in the described and illustrated exemplary embodiment has a smartphone by means of which the identification codes 12 are optoelectronically readable and on which an app, i.e., a computer program, is stored, with the aid of which the identification codes 12 can be evaluated. Instead of a smartphone, a tablet computer is also possible, for example, as an optoelectronic code reader 13 (not shown). The optoelectronic code reader 13 is connected via mobile Internet to a database 14, which is shown as a circuit symbol in the drawing. The anchor rail 1 and other anchor rails and all accessory parts 10 associated with the various anchor rails 1, including their associations with one or more anchor rails 1 and other suitable accessory parts 10, are stored in the database 14 in such a way that the optoelectronic code reader 13 can use the database 14 to check whether the accessory parts 10 arranged or attached on the anchor rail 1 are assigned to the anchor rail 1 and form a rail system with it or not. The database 14 is also part of the rail system according to the invention.

According to the invention, after the anchoring of the anchor rail 1 in the anchoring base 2 and the arrangement, fixing and/or fastening of the accessory parts 10 on the anchor rail 1, the identification codes 12 of the anchor rail 1 and all accessory parts 10 arranged thereon are read optoelectronically with the code reader 13 and checked as to whether the accessory parts 10 are associated with the anchor rail 1. It is possible and advantageous for the process flow on construction sites to check the association of an accessory part 10 with the anchor rail 1 before the accessory part 10 is arranged or fastened on the anchor rail 1.

In addition to the identification code 12, the hammer head screw 7, which can generally also be regarded as a component fastener 15, has a rotational position marking 16 with which the optoelectronic code reader 13 can detect a rotational position of the hammer head screw 7. “Rotational position” means in particular that the hammer head screw 7 is arranged transversely to the anchor rail 1, i.e., engages behind the anchor rail 1. When checking the association of the hammer head screw 7 or the component fastener 15 to the anchor rail 1, the optoelectronic code reader 13 also checks the rotational position of the hammer head screw 7 or the component fastener 15 in relation to the anchor rail 1 on the basis of the rotational position marking 16. If the hammer head screw 7 is not transverse to the anchor rail 1, the code reader 13 outputs a visual and/or acoustic warning.

In the exemplary embodiment, the hammer head screw 7 has two mutually parallel lines on opposite sides of the DMC code attached as identification code 12 at the hammer head screw 7 as the rotational position marking 16. Other rotational position markings 16 are possible, and the identification code 12 itself can optionally also be used as a rotational position marking 16, provided that the employed identification code 12 makes it possible to detect its rotational position.

Instead of the anchor rail 1, the rail system according to the invention can also have, for example, a mounting rail as the rail (not shown). In this case, it is typically likewise a C-profile rail which, however, is not anchored in an anchor base 2, but is fastened, for example, suspended under a ceiling. A mounting rail is assigned fasteners with which the mounting rail is suspended below the ceiling, hammer head screws as component fasteners and attachment parts as accessories (not shown).

### LIST OF REFERENCE SIGNS

1 Anchor rail
2 Anchor base
3 Upper side
4 Longitudinal slot
5 Base side
6 Anchor
7 Hammer head screw
8 Screw shaft
9 Attachment
10 Accessory part
11 Nut
12 Identification code
13 Code reader
14 Database
15 Component fastener
16 Rotational position marking

1. A rail system having an anchor or mounting rail and at least one accessory part associated with the anchor or mounting rail, wherein both the anchor rail or mounting rail as well as the at least one accessory part have an optoelectronically readable identification code.

2. The rail system according to claim 1, wherein the anchor or mounting rail and the at least one accessory part have identical identification codes.

3. The rail system according to claim 1, wherein the anchor or mounting rail and the at least one accessory part have different identification codes.

4. The rail system according to claim 1, wherein the rail system has a component fastener which can be brought into engagement behind the anchor or mounting rail to fasten an attachment part to the anchor or mounting rail as an accessory part.

5. The rail system according to claim 1, wherein the anchor or mounting rail has multiple identification codes, and/or that the identification code is arranged at a location of the anchor or mounting rail on which the identification code is accessible for optical reading when the anchor or mounting rail is fastened as provided.

6. The rail system according to claim 1, wherein the at least one accessory part has multiple identification codes, and/or that the identification code is arranged at a location of the at least one accessory part at which the identification code is accessible for optoelectronic reading when the at least one accessory part is arranged as provided on the anchor or mounting rail.

7. The rail system according to claim 4, wherein the component fastener has a rotational position marking with which a rotational position of the component fastener can be recognized with respect to the anchor or mounting rail.

8. The rail system according to claim 1, wherein the rail system has an optoelectronic code reader.

9. The rail system according to claim 8, wherein the rail system has a smartphone or a tablet computer as the optoelectronic code reader.

10. The rail system according to claim 1, wherein a database in which data relating to the anchor or mounting rail and associated accessory parts are stored is associated with the rail system.

11. A method for checking a rail system according to claim 1, wherein the identification code of the anchor rail or mounting rail and the at least one accessory part is read with the optoelectronic code reader, and an association of the at least one accessory part with the anchor or mounting rail is checked.

12. The method according to claim 11, wherein the association of the at least one accessory part is checked when the anchor or mounting rail is fastened as provided, and the at least one accessory part is arranged on the anchor or mounting rail.
